(19) United States
(12) Patent Application Publication
(10) Pub. No.: US 2002/0099664 A1
(43) Pub. Date: Jul. 25, 2002

(54) Method and apparatus for secure electronic transaction authentication

(76) Inventor: Ernest Cohen, Philadelphia, PA (US)

Correspondence Address: Joseph Giordano, Esq., Telcordia Technologies, Inc., 445 South Street, Rm. 1G112R, Morristown, NJ, 07960, US

(21) Appl. No.: 09/765,751

(22) Filed: Jan. 19, 2001

(51) Int. Cl. G06F 17/60

(52) U.S. Cl. 705/67

(57) ABSTRACT

Disclosed is a method and apparatus for authenticating a secure transaction by using information about the transaction and about the user, including a secret key. Secure information based upon information about the transaction, and information about the user, including a secret key is processed. This secure information is provided to the vendor as ordinary private transaction information, in the same manner as a credit card number, or a user name. A verifier, such as the user's bank, credit card company, a trusted authority, or the like, can then use the information about the transaction, the user, and the user's secret key to verify the secure information.

### BACKGROUND OF THE INVENTION

1. Field of the Invention

The present invention relates to conducting secure electronic transactions, such as secure credit card transactions over the Internet. In particular, the present invention relates to methods and apparatus for secure electronic transaction authentication.

2. Description of Related Art

It is commonly recognized that private information transmitted over the Internet is not secure. In one example, a dishonest vendor may improperly use private information received from a user. In another example, dishonest persons may convince an Internet user to reveal his or her credit card number. In yet another example, computer “hackers,” or other attackers, may gain access to an on-line vendor's web server and obtain customers' private information, such as their credit card numbers. An unauthorized person who has obtained private information may use that information to conduct fraudulent transactions, and sell it to others, for further unauthorized use.

In response to this known insecurity, a credit card industry consortium introduced the Secure Electronic Transaction protocol (SET). SET protocol is very different from the conventional credit card protocol in current use. The SET requires credit card holders to use specially designed “smart cards.” These smart cards are capable of digitally signing electronic transaction orders, such as on-line purchases. A drawback of the SET protocol is that vendors are required to have additional equipment to handle transactions that use these smart cards. Because the SET protocol requires additional equipment and handling than that required for conventional credit card handling, SET has not been received with great enthusiasm.

American Express has recently implemented a method for providing secure on-line transactions. It is believed that this method requires the card user to contact American Express directly to obtain a new card number. American Express then generates a random number. This random number prevents an unauthorized person from re-using that number for unauthorized transactions. This method does not require additional vendor equipment or handling. The use of a random number, however, does not prevent a dishonest vendor from changing the price of the transaction, nor does it authenticate the transaction amount, or authenticate the identity of the vendor.

Therefore, it is an object of the present invention to provide a method for secure electronic transaction authentication of the user and the transaction, and which does not require the vendor to perform a different handling method, or obtain additional equipment.

### SUMMARY OF THE INVENTION

This and other objects of the present invention are achieved by processing secure information based upon information about the transaction, and information about the user, including a secret key. This secure information is provided to the vendor as ordinary private transaction information, in the same manner as a credit card number or a user name. A verifier, such as the user's bank, credit card company, a trusted authority, or the like, can then use the information about the transaction, the user, and the user's secret key to verify the secure information.

In a first aspect of the invention, secure information is processed in the transaction between the user and the vendor. In a second aspect of the invention, a verifier having the user's secret key, such as the user's bank, credit card company, or a trusted authority receives the secure information and verifies it.

In the first aspect of the invention, a method for secure electronic transaction authentication is provided. The present invention first obtains transaction information from the vendor. Examples of the transaction information that may be received from the vendor may be one or more of the following: a URL of a vendor's web-site, the purchase amount, the transaction date, the transaction time, or other information preferably identifying the transaction. The present invention also obtains user identification information from the user including a secret key. The user information may be, for example, one or more of the user's name, address, an identification number, or other information that preferably identifies the user. Only the user and verifier preferably know the secret key. The present invention then processes secure information by electronically performing a message authentication code (“MAC”) function on at least some of the transaction information, and at least some of the user identification information using the secret key. The secure information that is the result of the MAC function is then used as a part of the private transaction information given to the vendor. For example, the secure information resulting from the MAC function may be used as a part of the credit card number information, or user name, that is normally given to the vendor during a transaction.

In the second aspect of the invention, a method for verifying secure information is provided. A verifier receives the secure information, transaction information, and user information from the vendor. The verifier knows the user's secret key. The verifier electronically performs the same MAC function on the transaction information and the user information received from the vendor using the secret key. The verifier compares the result of the MAC function with the received secure information. If the results of the verifier's MAC function are identical to the secure information (which is found in at least part of the received private transaction information), the transaction is verified. If the verifier's MAC function value is different from the received secure information. it is an indication the transaction information, user information, and/or secret key used by the verifier is not the same as was used to process the secure information. In that case, the transaction is not verified.

The present invention generates preferably unique values for use as ordinary private transaction information given to the vendors, such as credit card numbers. Because the MAC function preferably generates unique values for different pre-images, the likelihood of the same secure information being processed for two different transactions is remote. To the vendor, the values look like ordinary private transaction information, and thus no special handling or equipment is used. However, to the verifier, the secure information identifies both the user and the transaction. The private transaction information received by the vendor, even if stolen, cannot be used for future transactions. Additionally, the transaction information sent from the vendor to the verifier cannot be altered from information used to process the secure information.

### BRIEF DESCRIPTION OF THE DRAWINGS

The present invention is described with reference to the following figures:

FIG. 1 is a block diagram of a conventional computer or processor;

FIG. 2A illustrates a network over which conventional on-line transactions are conducted;

FIG. 2B illustrates a network over which on-line transactions according to a preferred embodiment of the present invention are conducted;

FIG. 3 is a flowchart illustrating a preferred method of performing a first aspect of the present invention; and

FIG. 4 is a flowchart illustrating a preferred method of performing a second aspect of the present invention.

### DETAILED DESCRIPTION OF PREFERRED EMBODIMENTS

Introduction

An understanding of one-way hash functions, secret keys, and message authentication code (“MAC”) functions is helpful to understand the present invention. Each of these terms, as used here, is described.

Hash Function: A hash function is a function that takes a variable length input string (often called a pre-image) and converts it into a fixed-length output string (often called a hash value). A one-way hash function is a hash function that is easy to compute but hard to invert on an overwhelming fraction of its range. In a good one-way hash function, given a hash value, it is computationally infeasible to determine the pre-image that hashed to that value. Another type of hash function is a collision resistant hash function. One important feature of a collision resistant hash function is that it is computationally intractable to generate two pre-images that hash to the same hash value. In a typical collision-free, one-way hash function, a change of one bit between pre-images results in an expectation that each bit of the hash has about a 50% chance of changing. Therefore, even a single bit difference results in an entirely different hash value. Well-known one-way hash functions include SHA and MD5.

Secret Key: A secret key is typically a large number that is known only to certain users, thus the term “secret.” “Secret key” as used here refers to a secret key in a MAC. Typically, in a MAC, the user uses the same secret key to generate the MAC as the verifier uses to verify the MAC.

Message Authentication Code: Generally, a MAC is a value computed using secret information (generally referred to herein as “a secret key”), which can be used as an authenticator for a message. Typically, a MAC is a key-dependent, collision resistant, one-way hash function. Only someone with the identical key can verify the hash. Well-known MAC functions are HMAC and MAA (Message Authentication Algorithm). A person skilled in the art recognizes that many MAC functions are suitable for use in the present invention and also recognizes that while hashing is one way in which to compute a MAC, a MAC may also be computed by other methods, such as through encryption.

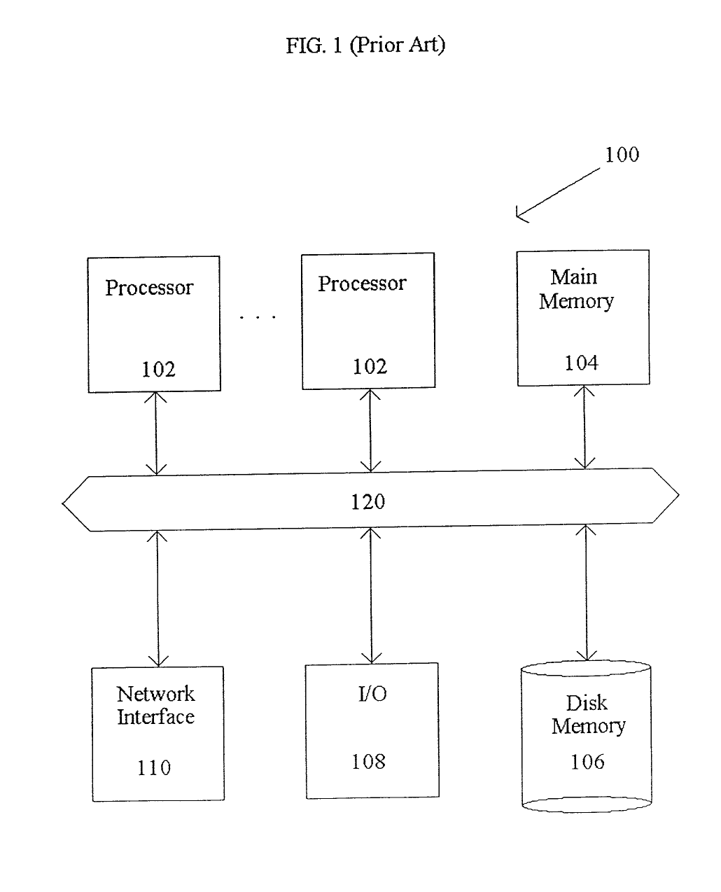

A computer (such as a desktop, laptop, palmtop, Personal Digital Assistant, or other type of computing device) or special purpose processor typically performs hash functions and message authentication code functions. FIG. 1 is a block diagram of a conventional computer or processor 100 which may be used to perform MAC functions. The device 100 has a processor including one or more CPUs 102, a main memory 104, a disk memory 106, an input/output device 108, and a network interface 100, which may be a wire line, wireless, or other interface type. The devices 102-110 are connected to a bus 120 that transfers data, i.e., instructions and information, between each of these devices 102-110. A MAC function algorithm may be stored as data in either main memory 104 or a disk memory 106. A pre-image may be provided at the I/O device 108 or network interface 110. The processor 102 may retrieve the algorithm from memory 104 or 106 and receive the pre-image from the I/O (or network interface 110), both via the bus 120. The processor 102 may perform the MAC and provide the MAC value to the I/O device 108 (or network interface 110) or store the MAC value in memory 104, 106.

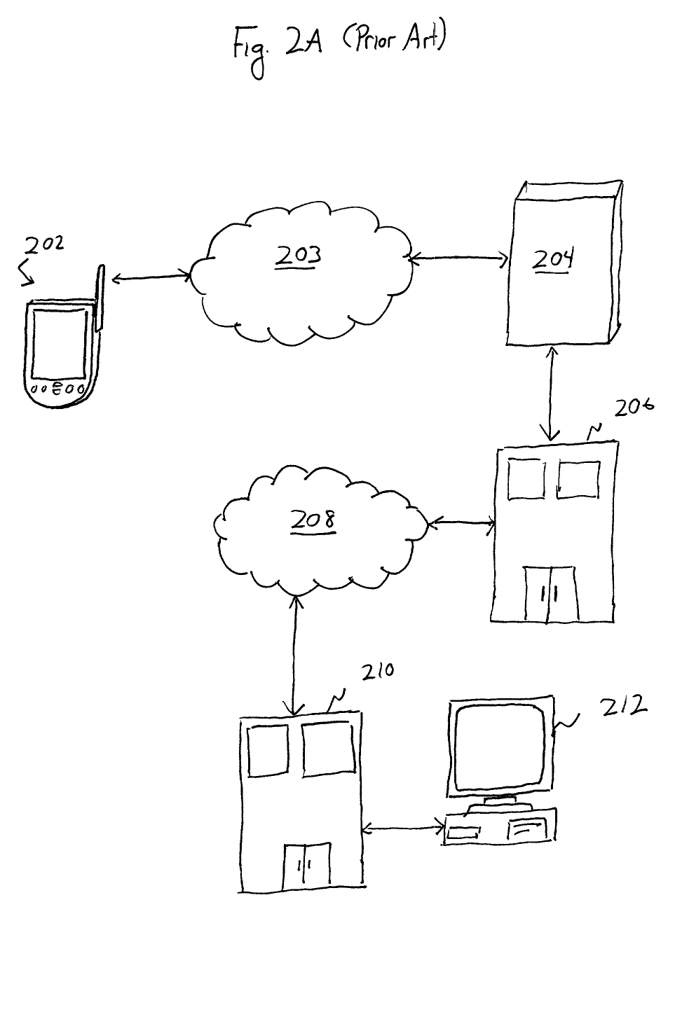

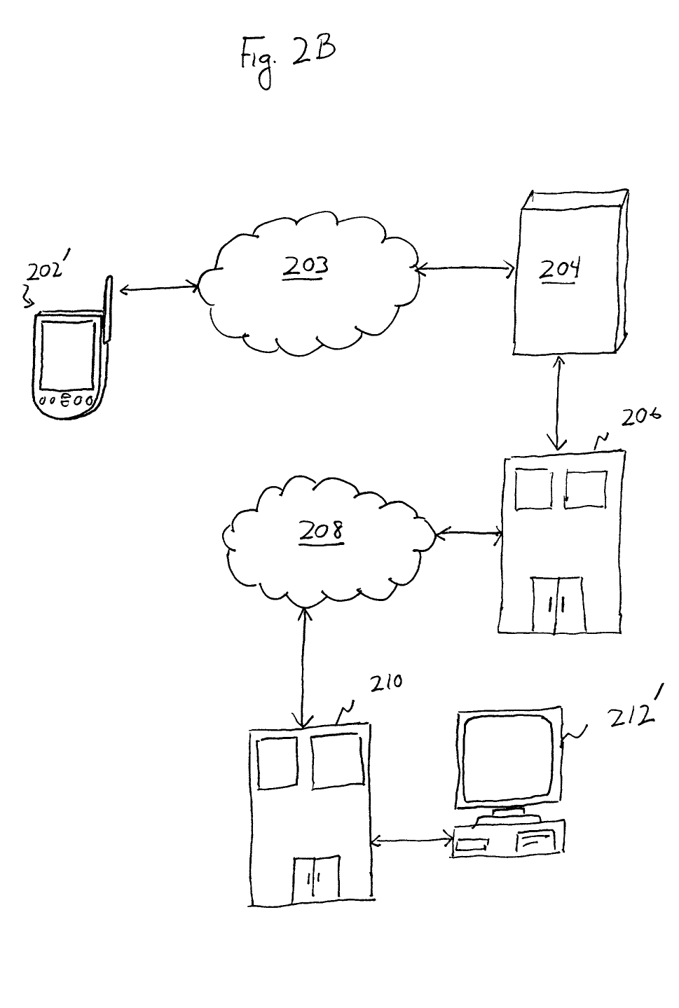

On-line transactions are typically conducted on a network as illustrated in FIG. 2A. A user uses a computer 202, such as the computer 100 described above. The computer 202 may have a connection to an open network 203, such as the Internet. The user's computer 202 may use the open network 203 to access a vendor's website, which may reside, for example, on a web server 204. While accessing the web site, the user may conduct a transaction in which private information is transmitted across the open network 203 to the web server 204. The vendor 206 obtains the private transaction information from the web server 204 and processes the private information. The vendor 206 may, for example, send credit card information over a private network 208 (such as a telephone network) to the user's bank, credit card company, or other verifier 210. The verifier 210 may use a computer 212, such as the computer 100 described above, to approve the transaction by verifying the user's private transaction information received from the vendor 206.

Overview

The present invention modifies the process described above in connection with FIG. 2A. These modifications are illustrated in FIG. 2B. According to the present invention, the user's computer 202′ is modified to perform the first aspect of the present invention. The user's computer 202′ uses information about the transaction, user identification, and/or a user's secret key to process secure information using a message authentication code (“MAC”) function. This secure information is used as part of the private transaction information transmitted over the open network 203 to the web server 204.

The vendor 206 handles the private transaction information in the usual manner. The vendor 206 may send the private transaction information, such as credit card information, over the private network 208 to the verifier 210, such as the user's credit card company, bank, a trusted authority, or the like.

The verifier receives the transaction information, the secure information found in the private transaction information, and user information from the vendor 206. The verifier's computer 212′ is modified to perform the second aspect of the present invention. The verifier's computer 212′ uses information about the transaction and user identification it received from the vendor, and the user's secret key (that it shares with the user), to process secure information using the same message authentication code (“MAC”) function performed by the user's computer 202′. The verifier 210 verifies the transaction by verifying the secure information resulting from its MAC function is the same as the secure information contained in the user's private transaction information received from the vendor 206. This verifies that the transaction and user information received from the vendor is the same information used to process the secure information with the user's secret key. (It is apparent to one skilled in the art that the invention may be used in networks other than the one illustrated in FIG. 2B.)

The present invention generates preferably unique values for use as ordinary private transaction information, such as credit card numbers. Because the MAC function generates preferably unique values for different inputs, the likelihood of the same secure information being used for two different transactions is remote. To the vendor 206, the values look like ordinary private transaction information, and thus no special processing or equipment is used. To the verifier 210, however, the secure information identifies both the user and the transaction. The private transaction information received by the vendor, even if stolen, cannot be used for future transactions. Also, the transaction information sent from the vendor to the verifier cannot be altered from information used to process the secure information.

The First Aspect of the Invention

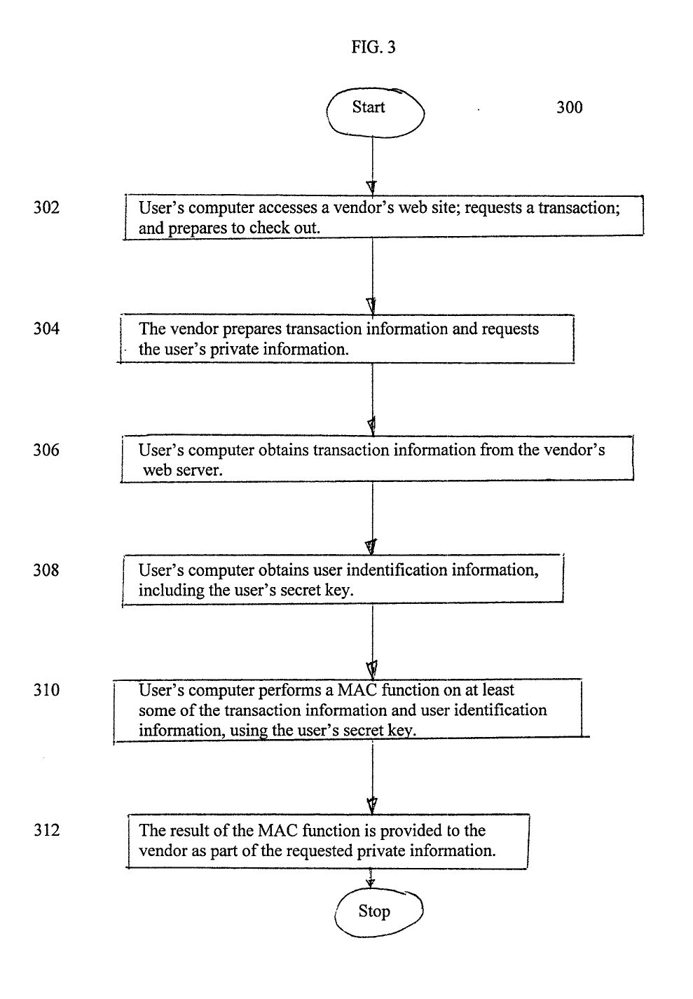

FIG. 3 is a flowchart 300 illustrating a preferred method of performing the first aspect of the present invention. Preferably, the user's computer 202′ performs this first aspect of the invention. The user's computer 202′ stores, for example, in main memory 104 or disc memory 106 of FIG. 1, user identification information, the user's secret key, and computer code for performing the first aspect of the present invention. The user identification information and secret key may have been supplied to the user's computer 202′ by, for example, the user's bank, credit card company, a trusted authority, or the like.

In step 302, the user's computer 202′ accesses a vendor's web site (i.e., the vendor's web server 204), requests a transaction (such as a purchase), and prepares to check out.

In step 304, the vendor prepares information regarding the transaction, such as calculating a total price, and presents the information to the user with a request for private transaction information, such as name, address, credit card number, or the like.

In step 306, the user's computer 202′ obtains transaction information from the vendor's web server 204. This transaction information may include one or more of the following: the vendor's URL (web site address), a transaction amount, a transaction date and/or time, a name or number of the item purchased, an invoice number, or other information which preferably identifies the transaction. In one embodiment of this invention, the user's computer automatically obtains the vendor's URL from the web browser history. Information may be obtained by any suitable method, such as by a heuristic analysis of the vendor's web page; from a directory of payment page information maintained by a bank or another party; by a standardized markup on the vendor's web page; or by manual entry by the user.

In step 308, the user's computer 202′ obtains (from main memory 104 or disc memory 206 of FIG. 1, for example) user information, including the user's secret key. The user information may be, for example, one or more of the user's name, address, an identification number, or other information that preferably identifies the user.

In step 310, the user's computer 202′ electronically (i.e., CPU 102) performs a MAC function on at least some of the transaction information and some of the user information.

312, the result of the MAC function, the secure information is used as at least part of the private transaction information requested by the vendor 206. This secure information can be inserted into the private transaction information by manually sending it to the vendor by the user, or automatically transferred to the vendor through the use of any suitable method, such as: a heuristic analysis of which field on a web page to put the information into; looking up the format of a particular site in an on-line directory provided by the bank or another party; or by the use of a standardized web markup.

The private transaction information containing the secure information may be supplied to the vendor, for example, as digits in the sixteen-digit credit card number. Because the first four digits of the credit card number identify the user's bank and financial institution, it is preferable not to use these digits as secure information. All or some of the remaining twelve digits may be used for the secure information. (Some hash functions may be tailored to a desired number of digits. Other alternatives to obtain the desired number of digits may be truncating a hash value that is too long, or padding a hash value that is not long enough.) Another example of how the secure information may be used as private transaction information is to convert the function results into letters (or any ASCII characters) and use the converted function results as the user's name. This alternative provides an additional advantage of user anonymity, because the actual name of the user is not revealed to the vendor. If the private transaction information is credit card information, for example, the expiration date of the credit card may be used to provide an additional five bits of secure information.

Another embodiment of this invention provides a unique counter value as an additional part of the pre-image that is hashed by the MAC function. By adding a unique counter value, multiple purchases of the same item, from the same merchant, on the same day, may be separately validated. Even if otherwise identical transaction information and user information are input into the MAC function, the counter provides an additional value that creates a unique pre-image. This results in the generation of a completely different secure information value for each transaction. This unique counter value may either be remembered by the bank, or sent by the user to the bank in the clear (just like the MAC itself).

To the vendor 206, the private transaction information looks like, and may be treated like, ordinary private transaction information. However, because the information has been “MACed” using transaction information, and user information, the secure information preferably will be a unique value. Even if an unauthorized person obtains this information, it cannot be used for any future purchases. In addition, a vendor 206 may handle secure information in the conventional way without requiring any additional handling or equipment.

The Second Aspect of the Invention

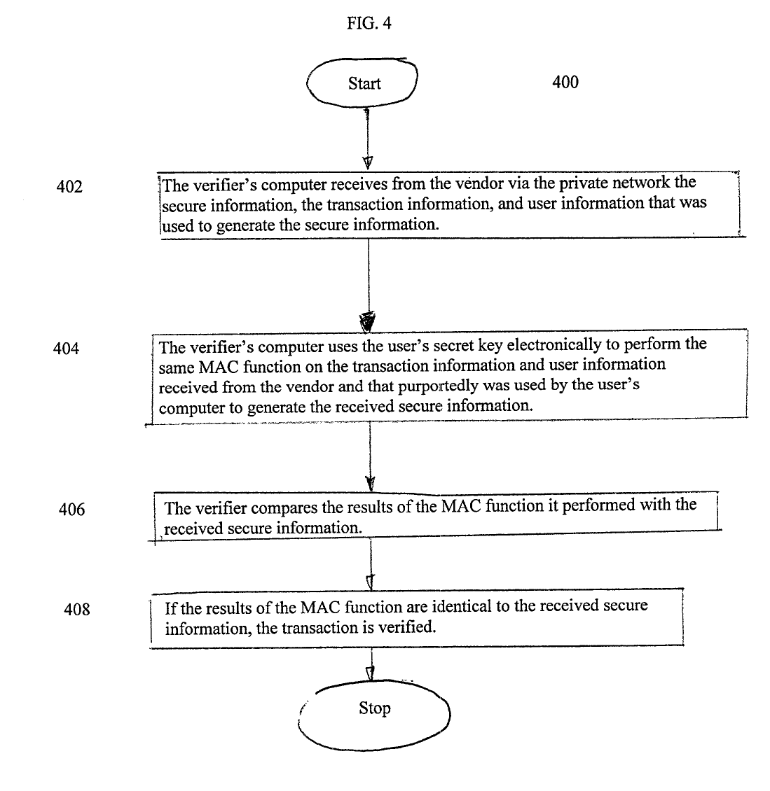

FIG. 4 is a flow chart 400 illustrating a preferred method of performing the second aspect of the present invention. Preferably, the verifier's computer 212′ performs this second aspect of the invention. The verifier's computer 212′ stores, for example, in main memory 104 or disc memory 106 of FIG. 1, the user's secret key, and computer code for performing the second aspect of the present invention. The verifier 210 may be, for example, the user's bank, credit card company, a trusted authority. or the like.

In step 402, the verifier's computer 212′ receives from the vendor 206, via the private network 208, the secure information and the transaction information and user information used to process the secure information. As described above, the secure information may be contained, as at least part of the private transaction information, such as credit card number, card expiration date, or user name.

In step 404, the verifier's computer 212′ uses the user's secret key electronically to perform the same MAC function on the transaction information and user information received from the vendor and that purportedly was used by the user's computer 202′ to process the received secure information.

In step 406, the verifier 210 compares the results of the MAC function it performed with the received secure information.

In step 408, if the results of the MAC function are identical to the received secure information the transaction is approved. (Assuming, of course, that other criteria, such as credit limit, have been met.)

The present invention allows the verifier 210 not only to verify the authenticity of the user (i.e., the purchase was not made by an unauthorized person), but also to verify information about the purchase (i.e., the transaction information was not altered by the vendor).

If the verifier's MAC result is the same as the secure information, the verifier 210 knows that the user, and not an imposter, performed the transaction because the user's secret key resulted in the correct MAC value. The verifier also knows that the transaction information received from the inventor has not been altered from the transaction made by the user because any change in the transaction information would result in a different MAC result.

The above-described embodiments of the invention are intended to be illustrative. Those skilled in the art recognize that numerous alternative embodiments may be devised without departing from the spirit and scope of the following claims.

I claim:

1. A method for secure electronic transaction authentication, comprising the steps of:
a. obtaining transaction information from a vendor;
b. obtaining user information, including a secret key from a user;
c. electronically performing a message authentication code (“MAC”) function on at least some of the transaction information and some of the user information; and
d. using a result of the MAC function as private transaction information.

2. The method of claim 1, wherein the step of obtaining transaction information comprises obtaining at least one of a name of the vendor, a URL, a transaction amount, a date of transaction, and a time of transaction.

3. The method of claim 1, further comprising the step of adding a counter value to the transaction information.

4. The method of claim 1, wherein the step of using the result of the MAC function comprises using the result as at least a part of a credit card number.

5. The method of claim 1, wherein the step of using the result of the MAC function as private transaction information comprises using the result as at least a part of a user's name.

6. A method for verifying secure information for a user, where the user has a secret key, comprising the steps of:
a. receiving the secure information;
b. receiving transaction information;
c. receiving user information;
d. electronically performing a message authentication code (“MAC”) function on at least some of the transaction information and at least some of the user information using the secret key;
e. comparing a result of the MAC function with the received secure information; and
f. verifying the received secure information if the result of the MAC function is identical to the received secure information.

7. The method of claim 6, wherein the step of receiving the secure information comprises receiving from a vendor private transaction information at least partially containing the result of the MAC function.

8. The method of claim 7, wherein the step of receiving from a vendor private transaction information further comprises receiving a user's name at least partially containing the results of the MAC function.

9. The method of claim 7, wherein the step of receiving from a vendor private transaction information further comprises receiving a credit card number at least partially containing the results of the MAC function.

10. The method of claim 6, wherein the step of receiving transaction information comprises receiving at least one of a name of the vendor, a URL, a transaction amount, a date of transaction, a time of transaction, a name of an item purchased, or an invoice number.

11. A method for conducting a secure electronic transaction, comprising the steps of:
a. obtaining transaction information from a vendor;
b. obtaining user information, including a secret key;
c. processing secure information by electronically performing a first MAC function on at least some of the transaction information and some of the user information using the secret key;
d. using the secure information in private transaction information;
e. a verifier receiving the secure information;
f. the verifier receiving the transaction information;
g. the verifier receiving the user information;
h. electronically performing a second MAC function on at least some of the transaction information and at least some of the user information using the secret key;
i. comparing a result of the second MAC function with the received secure information; and
j. verifying the received secure information if the result of the second MAC function are identical to the received secure information.

12. The method of claim 11, wherein the step of obtaining transaction information comprises obtaining at least one of a name of the vendor, a URL, a transaction amount, a date of transaction, a time of transaction, a name of an item purchased, or an invoice number.

13. The method of claim 11, wherein the step of using the secure information comprises using the result as at least a part of a credit card number.

14. The method of claim 11, wherein the step of using the secure information comprises using the result as at least a part of a user's name.

15. The method of claim 11, wherein the step of receiving the secure information comprises receiving from a vendor a credit card number at least partially containing the results of the first MAC function.

16. The method of claim 11, wherein the step of receiving the secure information comprises receiving from the vendor a user's name at least partially containing the result of the first MAC function.

17. The method of claim 11, comprising the step of further adding a counter value to the transaction information.

18. An apparatus for providing secure electronic transaction authentication comprising:
a. an input configured to obtain transaction information from a vendor, and user information from a user, including a user's secret key;
b. a processor configured to receive the transaction information and the user information and to electronically perform a MAC function on at least some of the transaction information and some of the user information using the secret key; and
c. an output configured to output a result of the MAC function for use as private transaction information.

19. The apparatus of claim 18, wherein the transaction information comprises at least one of a name of the vendor, a URL, a transaction amount, a date of transaction, and a time of transaction.

20. The apparatus of claim 18, wherein the processor is further configured to add a counter value to the transaction information.

21. The apparatus of claim 18, wherein the private transaction information comprises at least part of a credit card number.

22. The apparatus of claim 18, wherein the private transaction information comprises at least part of a user's name.

23. An apparatus for verifying secure information for a user, where the user has a secret key, comprising:
a. an input configured to receive the secure information, transaction information, and user information;
b. a processor configured to obtain the transaction information and the user information and to electronically perform a MAC function on at least some of the transaction information and at least some of the user information using the secret key;
c. the processor further configured to obtain the secure information and a result of the MAC function, and to compare the result of the MAC function with the received secure information; and
d. an output configured to output a verification of the secure information if the result of the MAC function are identical to the received secure information.

24. The apparatus of claim 23, wherein the private transaction information is a credit card number at least partially containing the secure information.

25. The apparatus of claim 23, wherein the private transaction information is a user's name at least partially containing the secure information.

26. The apparatus of claim 23, wherein the step of receiving transaction information comprises receiving at least one of a name of the vendor, a URL, a transaction amount, a date of transaction, a time of transaction, a name of an item purchased, and an invoice number.

27. An apparatus for conducting a secure electronic transaction, comprised of:
a. an input for receiving transaction information from a vendor, and for obtaining user information from the user, including a secret key;
c. a first processor configured to receive the transaction information and the user information and to process secure information by performing a first MAC function on at least some of the transaction information and some of the user information using the secret key;
d. an output configured to output the secure information for use in the secure electronic transaction;
e. a verifier input for receiving the secure information, the transaction information, and the user information;
f. a second processor configured to receive the transaction information and the user information, and to perform a second MAC function on at least some of the transaction information and at least some of the user information, and to compare a result of the second MAC function with the received secure information; and
g. an output configured to output a verification of the secure information if the result of the second MAC function are identical to the received secure information.

29. The apparatus of claim 27, wherein the transaction information is at least one of a name of the vendor, a URL, a transaction amount, a date of transaction, a time of transaction, a name of an item purchased, and an invoice number.

30. The apparatus of claim 27, wherein the secure information is used as at least a part of a credit card number.

31. The apparatus of claim 27, wherein the secure information is used as at least a part of a user's name.

32. The apparatus of claim 27, wherein the secure information is a credit card number at least partially containing the result of the first MAC function.

33. The apparatus of claim 27, wherein the secure information is a user's name at least partially containing the result of the first MAC function.

34. The apparatus of claim 27, wherein the processor for performing the first MAC function adds a counter value to the transaction information.
